(19) United States
(12) Patent Application Publication
(10) Pub. No.: US 2004/0109950 A1
(43) Pub. Date: Jun. 10, 2004

(54) Dielectric materials

(75) Inventors: Timothy G. Adams, Sudbury, MA (US); Gregory P. Prokopowicz, Lancaster, MA (US); Dana A. Gronbeck, Holliston, MA (US); Michael K. Gallagher, Hopkinton, MA (US)

Correspondence Address: EDWARDS & ANGELL, LLP, P.O. Box 9169, Boston, MA, 02209, US

(73) Assignee: Shipley Company, L.L.C., Marlborough, MA

(21) Appl. No.: 10/660,919

(22) Filed: Sep. 13, 2003

Related U.S. Application Data
(60) Provisional application No. 60/410,503, filed on Sep. 13, 2002.
(60) Provisional application No. 60/419,309, filed on Oct. 17, 2002.

(51) Int. Cl. B05D 3/02

(52) U.S. Cl. 427/387

(57) ABSTRACT

Organic polysilica materials containing one or more silicon-containing cross-linking agents having improved modulus and low dielectric constants and methods of preparing such materials are provided. These materials are useful in the manufacture of devices, such as electronic or optoelectronic devices, requiring low dielectric constant materials having good mechanical properties.

### BACKGROUND OF THE INVENTION

The present invention relates generally to the field of dielectric materials. In particular, the present invention relates to the filed of dielectric materials having improved mechanical properties for use in electronic and optoelectronic device manufacture.

Silica has been widely used as an insulating material in various devices, such as integrated circuits, and as an optical material in certain devices, such as waveguides. One reason for the wide use of silica films is that they possess very good mechanical properties and can be processed using a variety of techniques and conditions. However, silica films have a dielectric constant of approximately 4, which makes then unsuitable for certain uses.

As electronic devices become smaller, there is a continuing desire in the electronics industry to increase the circuit density in electronic components, e.g., integrated circuits, circuit boards, multichip modules, chip test devices, and the like without degrading electrical performance, e.g., crosstalk or capacitive coupling, and also to increase the speed of signal propagation in these components. Such goals require interlayer, or intermetal, insulating material having reduced dielectric constants, i.e. <<4. A method for reducing the dielectric constant of such interlayer, or intermetal, insulating material is to incorporate within the insulating film very small, uniformly dispersed pores or voids. In the case of silica films, such pores reduce the dielectric constant to below 4, however, it is still not low enough for many electronics applications.

As an alternative to silica films, organic polysilica films, such as methylsilsesquioxane or phenylsilsesquioxane films, have been suggested. Organic polysilica films have a lower dielectric constant than silica films which makes them better as insulating materials for advanced electronics applications. However, the dielectric constant of organic polysilica films is not low enough for certain applications. As a result, porous organic polysilica films have been developed, e.g. see U.S. Pat. No. 6,271,273 (You et al.).

One drawback to the use of organic polysilica films is that their mechanical properties are not as good as those of silica films. For instance, organic polysilica films are not as hard as silica films, which presents challenges during certain manufacturing processes, such as planarization of layers in the manufacture of integrated circuits. By making such organic polysilica films porous, the mechanical properties of the films are further affected.

One approach to improving the mechanical properties of organic polysilica films is disclosed in U.S. Pat. No. 4,349,609 (Takeda et al.). In this patent, a composition of a silsesquioxane and a tetraalkoxysilane is used to form an insulating film. Such film has a higher cross-link density as compared to a silsesquioxane homopolymers and has enhanced mechanical properties, such as scratch resistance. A problem with this approach is that the tetraalkoxysilanes (which are themselves used to form silica films) increase the dielectric constant of these silsesquioxane films, making such films unsuitable for many advanced electronics applications.

Cross-linkers for organic polysilica films that do not significantly increase the dielectric constant of the organic polysilica films are being sought. For example, Japanese published Patent Application No. 2001-40092 (Nishikawa et al.) discloses an organic polysilica condensation product of an organosilane with a compound having two silicon atoms having hydrolysable groups. This patent application fails to recognize that low molecular weight condensation products provide organic polysilica materials having enhanced mechanical properties. While such cross-linkers do not increase the dielectric constant of the organic polysilica materials significantly, such cross-linked organic polysilica materials still do not possess the desired mechanical properties. Organic polysilica films having low dielectric constants and improved mechanical properties, such as modulus, are clearly needed for advanced electronic devices.

### SUMMARY OF THE INVENTION

The present invention provides a composition comprising an organic polysilica partial condensate of one or more silanes of formula (I) and one or more silanes of formula (II):

RₐSiY₄₋ₐ (I)

R¹_{b}(R²O)_{3-b}Si(R³)_{c}Si(OR⁴)_{3-d}R⁵_{d} (II)

wherein R is hydrogen, (C₁-C₈)alkyl, (C₇-C₁₂)arylalkyl, substituted (C₇-C₁₂)arylalkyl, aryl, and substituted aryl; Y is any hydrolyzable group; a is an integer of 1 to 2; R¹, R², R⁴ and R⁵ are independently selected from hydrogen, (C₁-C₆)alkyl, (C₇-C₁₂)arylalkyl, substituted (C₇-C₁₂)arylalkyl, aryl, and substituted aryl; R³ is (C₁-C₁₀)alkyl, —(CH₂)ₕ—, —(CH₂)ₕ₁-Eₖ-(CH₂)ₕ₂—, —(CH₂)ₕ-Z, arylene, substituted arylene, or arylene ether; E is oxygen, NR⁶ or Z; Z is aryl or substituted aryl; R⁶ is hydrogen, (C₁-C₆)alkyl, aryl or substituted aryl; b and d are each an integer of 0 to 2; c is an integer of 0 to 6; and h, h1, h2 and k are independently an integer from 1 to 6; provided that at least one of R, R¹, R³ and R⁵ is not hydrogen; wherein the partial condensate has a weight average molecular weight of ≦10,000.

Also provided by the present invention is a method of preparing an organic polysilica partial condensate comprising the steps of reacting a mixture comprising a) one or more silanes of the formula RₐSiY₄₋ₐ, b) one or more silanes of the formula R¹_{b}(R²O)_{3-b}Si(R³)_{c}Si(OR⁴)_{3-d}R⁵_{d} and c) water at a temperature of ≦55° C.; wherein R is hydrogen, (C₁-C₈)alkyl, (C₇-C₁₂)arylalkyl, substituted (C₇-C₁₂)arylalkyl, aryl, and substituted aryl; Y is any hydrolyzable group; a is an integer of 1 to 2; R¹, R², R⁴ and R⁵ are independently selected from hydrogen, (C₁-C₆)alkyl, (C₇-C₁₂)arylalkyl, substituted (C₇-C₁₂)arylalkyl, aryl, and substituted aryl; R³ is (C₁-C₁₀)alkyl, —(CH₂)ₕ—, —(CH₂)ₕ₁-Eₖ-(CH₂)ₕ₂—, —(CH₂)ₕ-Z, arylene, substituted arylene, or arylene ether; E is oxygen, NR or Z; Z is aryl or substituted aryl; R⁶ is hydrogen, (C₁-C₆)alkyl, aryl or substituted aryl; b and d are each an integer of 0 to 2; c is an integer of 0 to 6; and h, h1, h2 and k are independently an integer from 1 to 6; provided that at least one of R, R¹, R³ and R⁵ is not hydrogen.

Further provided by the present invention is a method of preparing an organic polysilica film comprising the step of providing a partial condensate of one or more silanes of formula (I) and one or more silanes of formula (II):

RₐSiY₄₋ₐ (I)

R¹_{b}(R²O)_{3-b}Si(R³)_{c}Si(OR⁴)_{3-d}R⁵_{d} (II)

wherein R is hydrogen, (C₁-C₈)alkyl, (C₇-C₁₂)arylalkyl, substituted (C₇-C₁₂)arylalkyl, aryl, and substituted aryl; Y is any hydrolyzable group; a is an integer of 1 to 2; R¹, R², R⁴ and R⁵ are independently selected from hydrogen, (C₁-C₆)alkyl, (C₇-C₁₂)arylalkyl, substituted (C₇-C₁₂)arylalkyl, aryl, and substituted aryl; R³ is (C₁-C₁₀)alkyl, —(CH₂)ₕ—, —(CH₂)ₕ₁-Eₖ-(CH₂)ₕ₂—, —(CH₂)ₕ-Z, arylene, substituted arylene, or arylene ether; E is oxygen, NR⁶ or Z; Z is aryl or substituted aryl; R⁶ is hydrogen, (C₁-C₆)alkyl, aryl or substituted aryl; b and d are each an integer of 0 to 2; c is an integer of 0 to 6; and h, h1, h2 and k are independently an integer from 1 to 6; provided that at least one of R, R¹, R³ and R⁵ is not hydrogen; wherein the partial condensate has a weight average molecular weight of ≦10,000.

The present invention still further provides a method of manufacturing a device comprising the steps of: a) disposing on a substrate an organic polysilica partial condensate of one or more silanes of formula (I) and one or more silanes of formula (II):

RₐSiY₄₋ₐ (I)

R¹_{b}(R²O)_{3-b}Si(R³)_{c}Si(OR⁴)_{3-d}R⁵_{d} (II)

wherein R is hydrogen, (C₁-C₈)alkyl, (C₇-C₁₂)arylalkyl, substituted (C₇-C₁₂)arylalkyl, aryl, and substituted aryl; Y is any hydrolyzable group; a is an integer of 1 to 2; R¹, R², R⁴ and R⁵ are independently selected from hydrogen, (C₁-C₆)alkyl, (C₇-C₁₂)arylalkyl, substituted (C₇-C₁₂)arylalkyl, aryl, and substituted aryl; R³ is (C₁-C₁₀)alkyl, —(CH₂)ₕ—, —(CH₂)ₕ₁-Eₖ-(CH₂)ₕ₂—, —(CH₂)ₕ-Z, arylene, substituted arylene, or arylene ether; E is oxygen, NR⁶ or Z; Z is aryl or substituted aryl; R⁶ is hydrogen, (C₁-C₆)alkyl, aryl or substituted aryl; b and d are each an integer of 0 to 2; c is an integer of 0 to 6; and h, h1, h2 and k are independently an integer from 1 to 6; provided that at least one of R, R¹, R³ and R⁵ is not hydrogen; wherein the partial condensate has a weight average molecular weight of ≦10,000; and b) curing the organic polysilica partial condensate to form an organic polysilica film.

In addition, the present invention provides a composition including an organic polysilica partial condensate

### BRIEF DESCRIPTION OF THE DRAWING

FIG. 1 shows a plot of elastic modulus versus weight average molecular weight for a cross-linked organic polysilica film.

FIG. 2 shows plots of elastic modulus versus weight average molecular weight for two cross-linked organic polysilica films having different levels of porosity.

FIG. 3 shows plots of elastic modulus versus level of porosity in two cross-linked polysilica films.

### DETAILED DESCRIPTION OF THE INVENTION

As used throughout this specification, the following abbreviations shall have the following meanings, unless the context clearly indicates otherwise: ° C.=degrees centigrade; μm=micron=micrometer; ca.=approximately; UV=ultraviolet; rpm=revolutions per minute; min.=minute; hr.=hour; nm=nanometer; g=gram; % wt=% by weight; L=liter; mL=milliliter; ppm=parts per million; eq=equivalents; GPa=gigaPascals; Mw=weight average molecular weight; Mn=number average molecular weight; PGMEA=propylene glycol monomethyl ether acetate; HEMA=hydroxyethyl methacrylate; HPMA=hydroxypropyl methacrylate; ALMA=allyl methacrylate; PETA=pentaerythritol triacrylate; PETMA=pentaerythritol trimethacrylate; TMPTA=trimethylolpropane triacrylate; TMPTMA=trimethylolpropane trimethacrylate; and MMA=methyl methacrylate The term “(meth)acrylic” includes both acrylic and methacrylic and the term “(meth)acrylate” includes both acrylate and methacrylate. Likewise, the term “(meth)acrylamide” refers to both acrylamide and methacrylamide. “Alkyl” includes straight chain, branched and cyclic alkyl groups. The term “polymer” includes both homopolymers and copolymers. The terms “oligomer” and “oligomeric” refer to dimers, trimers, tetramers and the like. “Monomer” refers to any ethylenically or acetylenically unsaturated compound capable of being polymerized. Such monomers may contain one or more double or triple bonds. “Cross-linker” and “cross-linking agent” are used interchangeably throughout this specification and refer to a compound having two or more groups capable of being polymerized. As used herein, the terms “cure” and “curing” refer to polymerization, condensation or any other reaction where the molecular weight of a compound is increased. The step of solvent removal alone is not considered “curing” as used in this specification. However, a step involving both solvent removal and, e.g., polymerization is within the term “curing” as used herein. The term “organic polysilica” material (or organo siloxane) refers to a material including silicon, carbon, oxygen and hydrogen atoms.

Unless otherwise noted, all amounts are percent by weight and all ratios are by weight. All numerical ranges are inclusive and combinable in any order, except where it is clear that such numerical ranges are constrained to add up to 100%.

The present invention provides an organic polysilica film having a low dielectric constant and improved mechanical properties. The dielectric constant of such films is <4, preferably <3 and more preferably ≦2.95. Such organic polysilica films are prepared using a partial condensate of one or more organosilanes and one or more silicon-containing cross-linking agent, wherein the cross-linking agent contains >4 hydrolyzable groups. Particularly suitable silicon-containing cross-linking agents have 5 or 6 hydrolyzable groups. As used herein, the term “partial condensate” refers to a silane oligomer or prepolymer or hydrolyzate that is capable of undergoing further condensation reactions to increase its molecular weight.

In one embodiment, the organic polysilica films are prepared using a partial condensate of one or more organosilanes and one or more silanes of formula (I) and one or more silanes of formula (II):

RₐSiY₄₋ₐ (I)

R¹_{b}(R²O)_{3-b}Si(R³)_{c}Si(OR⁴)_{3-d}R⁵_{d} (II)

wherein R is hydrogen, (C₁-C₈)alkyl, (C₇-C₁₂)arylalkyl, substituted (C₇-C₁₂)arylalkyl, aryl, and substituted aryl; Y is any hydrolyzable group; a is an integer of 1 to 2; R¹, R², R⁴ and R⁵ are independently selected from hydrogen, (C₁-C₆)alkyl, (C₇-C₁₂)arylalkyl, substituted (C₇-C₁₂)arylalkyl, aryl, and substituted aryl; R³ is (C₁-C₁₀)alkyl, —(CH₂)ₕ—, —(CH₂)ₕ₁-Eₖ-(CH₂)ₕ₂—, —(CH₂)ₕ-Z, arylene, substituted arylene, or arylene ether; E is oxygen, NR⁶ or Z; Z is aryl or substituted aryl; R⁶ is hydrogen, (C₁-C₆)alkyl, aryl or substituted aryl; b and d are each an integer of 0 to 2; c is an integer of 0 to 6; and h, h1, h2 and k are independently an integer from 1 to 6; provided that at least one of R, R¹, R³ and R⁵ is not hydrogen; wherein the partial condensate has a weight average molecular weight of ≦10,000. “Substituted arylalkyl”, “substituted aryl” and “substituted arylene” refer to an arylalkyl, aryl or arylene group having one or more of its hydrogens replaced by another substituent group, such as cyano, hydroxy, mercapto, halo, (C₁-C₆)alkyl, (C₁-C₆)alkoxy, and the like. “Halo” refers to fluoro, chloro, bromo and iodo.

It is preferred that R is (C₁-C₄)alkyl, benzyl, hydroxybenzyl, phenethyl or phenyl, and more preferably methyl, ethyl, iso-butyl, tert-butyl or phenyl. Suitable hydrolyzable groups for Y include, but are not limited to, halo, (C₁-C₆)alkoxy, acyloxy and the like, and preferably chloro and (C₁-C₂)alkoxy. Suitable organosilanes of formula (I) include, but are not limited to, methyl trimethoxysilane, methyl triethoxysilane, phenyl trimethoxysilane, phenyl triethoxysilane, tolyl trimethoxysilane, tolyl triethoxysilane, propyl tripropoxysilane, iso-propyl triethoxysilane, iso-propyl tripropoxysilane, ethyl trimethoxysilane, ethyl triethoxysilane, iso-butyl triethoxysilane, iso-butyl trimethoxysilane, tert-butyl triethoxysilane, tert-butyl trimethoxysilane, cyclohexyl trimethoxysilane, cyclohexyl triethoxysilane, benzyl trimethoxysilane, benzyl triethoxysilane, phenethyl trimethoxysilane, hydroxybenzyl trimethoxysilane, hydroxyphenylethyl trimethoxysilane and hydroxyphenylethyl triethoxysilane.

Organosilanes of formula (II) preferably include those wherein R¹ and R⁵ are independently (C₁-C₄)alkyl, benzyl, hydroxybenzyl, phenethyl or phenyl. Preferably R¹ and R⁵ are methyl, ethyl, tert-butyl, iso-butyl and phenyl. Preferably R³ is (C₁-C₁₀)alkyl, —(CH₂)ₕ—, arylene, arylene ether and —(CH₂)ₕ₁-E-(CH₂)ₕ₂. Suitable compounds of formula (II) include, but are not limited to, those wherein R³ is methylene, ethylene, propylene, butylene, hexylene, norbornylene, cycloheylene, phenylene, phenylene ether, naphthylene and —CH₂—C₆H₄—CH₂—. It is further preferred that c is 1 to 4.

Suitable organosilanes of formula (II) include, but are not limited to, bis(trimethoxysilyl)methane, bis(triethoxysilyl)methane, bis(triphenoxysilyl)methane, bis(dimethoxymethylsilyl)methane, bis(diethoxymethyl-silyl)methane, bis(dimethoxyphenylsilyl)methane, bis(diethoxyphenylsilyl)methane, bis(methoxydimethylsilyl)methane, bis(ethoxydimethylsilyl)methane, bis(methoxydiphenylsilyl)methane, bis(ethoxydiphenylsilyl)methane, bis(trimethoxysilyl)ethane, bis(triethoxysilyl)ethane, bis(triphenoxysilyl)ethane, bis(dimethoxymethylsilyl) ethane, bis(diethoxymethylsilyl)ethane, bis(dimethoxyphenylsilyl)ethane, bis(diethoxyphenylsilyl)ethane, bis(methoxydimethylsilyl)ethane, bis(ethoxydimethylsilyl)ethane, bis(methoxydiphenylsilyl)ethane, bis(ethoxydiphenylsilyl)ethane, 1,3-bis(trimethoxysilyl))propane, 1,3-bis(triethoxysilyl)propane, 1,3-bis(triphenoxysilyl)propane, 1,3-bis(dimethoxymethylsilyl)propane, 1,3-bis(diethoxymethylsilyl)propane, 1,3-bis(dimethoxyphenylsilyl)propane, 1,3-bis(diethoxyphenylsilyl)propane, 1,3-bis(methoxydimehylsilyl)propane, 1,3-bis(ethoxydimethylsilyl)propane, 1,3-bis(methoxydiphenylsilyl)propane, 1,3-bis(ethoxydiphenylsilyl)propane, and the like.

Suitable organic polysilica materials include, but are not limited to, silsesquioxanes, partially condensed halosilanes or alkoxysilanes such as partially condensed by controlled hydrolysis tetraethoxysilane having number average molecular weight of 500 to 20,000, organically modified silicates having the composition RSiO₃, O₃SiRSiO₃, R₂SiO₂ and O₂SiR₃SiO₂ wherein R is an organic substituent, and partially condensed orthosilicates having Si(OR)₄ as the monomer unit. Silsesquioxanes are polymeric silicate materials of the type RSiO_{1.5} where R is an organic substituent. Suitable silsesquioxanes are alkyl silsesquioxanes; aryl silsesquioxanes; alkyl/aryl silsesquioxane mixtures; and mixtures of alkyl silsesquioxanes. Silsesquioxane materials include homopolymers of silsesquioxanes, copolymers of silsesquioxanes or mixtures thereof. Such materials are generally commercially available or may be prepared by known methods.

In an alternate embodiment, the organic polysilica materials may contain a wide variety of other monomers in addition to the silicon-containing monomers described above. For example, the organic polysilica materials may further comprise a second cross-linking agent, and carbosilane moieties.

Suitable second cross-linking agents may be any known cross-linkers for silicon-containing materials. Typical second cross-linking agents include silanes of the formula Mⁿ(OR¹¹)ₙ wherein M is aluminum, titanium, zirconium, silicon, magnesium, or boron; R¹¹ is (C₁-C₆)alkyl, acyl, or Si(OR¹²)₃; R¹² is (C₁-C₆)alkyl or acyl; and n is the valence of M. In one embodiment, R¹¹ is methyl, ethyl, propyl or butyl. In another embodiment, M is aluminum, titanium, zirconium or silicon. It will be appreciated by those skilled in the art that a combination of such second cross-linkers may be used. The ratio of the mixture of silanes of formulae (I) and (II) to such second cross-linking agents organosilanes is typically from 99:1 to 1:99, preferably from 95:5 to 5:95, more preferably from 90:10 to 10:90.

Carbosilane moieties refer to moieties having a (Si—C)ₓ structure, such as (Si-A)ₓ structures wherein A is a substituted or unsubstituted alkylene or arylene, such as SiR₃CH₂—, —SiR₂CH₂—, ═SiRCH₂—, and ═SiCH₂—, where R is usually hydrogen but may be any organic or inorganic radical. Suitable inorganic radicals include organosilicon, siloxyl, or silanyl moieties. These carbosilane moieties are typically connected “head-to-tail”, i.e. having Si—C—Si bonds, in such a manner that a complex, branched structure results. Particularly useful carbosilane moieties are those having the repeat units (SiHₓCH₂) and (SiH_{y-1}(CH═CH₂)CH₂), where x=0 to 3 and y=1 to 3. These repeat units may be present in the organic polysilica resins in any number from 1 to 100,000, and preferably from 1 to 10,000. Suitable carbosilane precursors are those disclosed in U.S. Pat. No. 5,153,295 (Whitmarsh et al.) and U.S. Pat. No. 6,395,649 (Wu).

The organic polysilica partial condensates are prepared by reacting one or more tri-or di-functional organo silanes such as those of formula I, one or more silicon-containing cross-linking agents such as those of formula II, and water at a temperature of ≦55° C., for a period of time sufficient to hydrolyze (or partially condense) the silanes to form a partial condensate having the desired weight average molecular weight. Typically, the reaction temperature is ≦40° C., preferably ≦35° C., and more preferably ≦30° C. It will be appreciated by those skilled in the art that certain silanes may require temperatures higher than 55° C. in order for them to react. Such higher temperatures are within this invention, provided that the weight average molecular weight of the partial condensates is ≦10,000. The amount of water is typically present in an amount of from 0.1 to 1.5 mole equivalents, preferably from 0.25 to 1 mole equivalents, and more preferably from 0.5 to 1 mole equivalents. The silanes and water are typically reacted from 0.5 to 48 hours, although longer times may be used. Particularly suitable reaction times are from 1 to 24 hours. The amount of the silanes may vary over a wide range. The mole ratio of the one or more silanes of formula (I) to the one or more silanes of formula (II) is from 99:1 to 1:99, particularly from 95:5 to 5:95, more particularly from 90:10 to 10:90, and still more particularly from 80:20 to 20:80.

Optionally, a catalyst may be used in the partial condensation reaction. Such catalyst may be either acidic or basic. Suitable catalysts include mineral acids such as hydrochloric acid, formic acid, carboxylic acids having a pKa >4, and bases such as amines including primary, secondary and tertiary amines as well as ammonium hydroxide and tetraalkylammonium hydroxides. Suitable base catalysts include without limitation cyclohexylamine, dicyclohexylamine, triethylamine, ammonium salts of carboxylic acids, and the like. When such catalysts are used, they may be used in a wide range of amounts. Typical catalyst amounts are from 0.1 to 1000 ppm, and preferably from 1 to 800 ppm. When mineral acids are used as the catalyst, they are typically used in an amount of 1 to 100 ppm and preferably from 1 to 25 ppm.

The organic polysilica partial condensates typically have a weight average molecular weight suitable to provide enhanced mechanical properties, such as elastic modulus. Typically, such partial condensates have a weight average molecular weight of ≦10,000, preferably ≦7500, and more preferably ≦5000, as determined using gel permeation chromatography (“GPC”) with a polystyrene standard. Exemplary ranges of weight average molecular weight are from 2500 to 10,000 from 2800 to 7500, and from 3000 to 5000. The weight average molecular weight may be increased or decreased as desired by changing the process conditions used to prepare the partial condensates. For example, increasing the reaction temperature tends to increase the molecular weight of the partial condensates. Likewise, increasing the reaction time at a given temperature also tends to increase the molecular weight of the partial condensate. For an acid catalyzed system, increasing the amount of catalyst tends to decrease the molecular weight of the partial condensate. The selection of such conditions will not require significant experimentation by one skilled in the art to provide an organic polysilica partial condensate having a desired weight average molecular weight.

When an optional catalyst is used, it is preferred that it is removed from the partial condensate prior to further processing. Catalysts may be removed from the partial condensate by contacting the partial condensate with a catalyst removing agent. A problem with the catalyst remaining is that it may cause further condensation of the partial condensate. If sufficient further condensation occurs, the weight average molecular weight of the material may exceed 10,000. Such acid catalysts may be removed by a variety of processes, such as contacting the partial condensate with a weak amine ion exchange resin (such as those sold by Rohm and Haas Company under the trademark IRA-67), chelating mixed-bed ion exchange reins (such as those described in U.S. Pat. No. 5,702,611), basic alumina, basic clays and the like. Base catalysts may also be removed by a variety of procedures, such as strong acid ion exchange resins (such as those sold by Rohm and Haas Company under the trademarks AMBERLITE IRN-77 and AMBERLYST 15), strong acid/strong base mixed-bed ion exchange resins (such as IRN-150 available from Rohm and Haas Company), weak acid ion exchange resins (such as AMBERLITE IRC-748 and AMBERLITE IRC-50, also available from Rohm and Haas Company), chelating mixed-bed ion exchange resins, and the like. Ion exchange resins are typically conditioned prior to use and such conditioning is well known to those skilled in the art.

Accordingly, the present invention provides a method of preparing an organic polysilica partial condensate comprising the steps of: a) reacting one or more organosilanes and water in the presence of a condensation catalyst at a temperature and time sufficient to provide an organic polysilica partial condensate having a desired molecular weight, and b) treating the partial condensate with a catalyst removing agent, to remove substantially all of the catalyst, i.e, less than 1% of the catalyst remains after treatment with the catalyst removing agent. Typical contact times for the catalyst removing agent are from 1 minute to 10 hours, more typically from 0.25 to 5 hours and even more typically from 0.5 to 3 hours.

A stabilizing agent may be optionally added to the partial condensates. Such stabilizing agents are preferably organic acids. Any organic acid having at least 2 carbons and having an acid dissociation constant (“pKa”) of about 1 to about 4 at 25° C. is suitable. Preferred organic acids have a pKa of about 1.1 to about 3.9, and more preferably about 1.2 to about 3.5. Organic acids capable of functioning as chelating agents are preferred. Such chelating organic acids include polycarboxylic acids such as di-, tri-, tetra- and higher carboxylic acids, and carboxylic acids substituted with one or more of hydroxyls, ethers, ketones, aldehydes, amine, amides, imines, thiols and the like. Preferred chelating organic acids are polycarboxylic acids and hydroxy-substituted carboxylic acids. The term “hydroxy-substituted carboxylic acids” includes hydroxy-substituted polycarboxylic acids. Suitable organic acids include, but are not limited to: oxalic acid, malonic acid, methylmalonic acid, dimethylmalonic acid, maleic acid, malic acid, citramalic acid, tartaric acid, phthalic acid, citric acid, glutaric acid, glycolic acid, lactic acid, pyruvic acid, oxalacetic acid, α-ketoglutaric acid, salicylic acid and acetoacetic acid. Preferred organic acids are oxalic acid, malonic acid, dimethylmalonic acid, citric acid and lactic acid, and more preferably malonic acid. Mixtures of organic acids may be advantageously used in the present invention. Those skilled in the art will realize that polycarboxylic acids have a pKa value for each carboxylic acid moiety in the compound. Only one of the pKa values in such polycarboxylic acids needs to be within the range of 1 to 4 at 25° C. for the organic acid to be suitable for use in the present invention. Such stabilizing agents are typically used in an amount of 1 to 10,000 ppm and preferably from 10 to 1000 ppm.

It will be appreciated that a mixture of dielectric materials may be used, such as two or more organic polysilica partial condensates or a mixture of an organic polysilica partial condensates with one or more other dielectric materials, i.e. not an organic polysilica dielectric material. Suitable other dielectric materials include, but are not limited to, inorganic matrix materials such as carbides, oxides, nitrides and oxyfluorides of silicon, boron, or aluminum; and organic matrix materials such as benzocyclobutenes, poly(aryl esters), poly(ether ketones), polycarbonates, polyimides, fluorinated polyimides, polynorbornenes, poly(arylene ethers), polyaromatic hydrocarbons, such as polynaphthalene, polyquinoxalines, poly(perfluorinated hydrocarbons) such as poly(tetrafluoroethylene), and polybenzoxazoles. It is preferred that when a mixture of an organic polysilica partial condensate and another dielectric material is used, the organic polysilica partial condensate is present as a predominant component.

The organic polysilica partial condensates may be disposed on any substrate to form a film. Particularly suitable substrates are those useful in the manufacture of electronic and optoelectronic devices. Suitable electronic devices include, but are not limited to, interconnect structures, semiconductors, semiconductor packaging, printed wiring boards, and the like. Particular electronic device substrates include, but are not limited to: silicon, silicon on insulator, silicon germanium, silicon dioxide, glass, silicon nitride, ceramics, aluminum, copper, gallium arsenide, plastics, such as polycarbonate, circuit boards, such as FR-4 and polyimide, and hybrid circuit substrates, such as aluminum nitride-alumina. Such substrates may further include thin films deposited thereon, such films including, but not limited to: metal nitrides, metal carbides, metal silicides, metal oxides, and mixtures thereof. In a multilayer integrated circuit device, an underlying layer of insulated, planarized circuit lines can also function as a substrate.

The term “optoelectronic devices” as used herein is also intended to include photonic devices. Suitable optoelectronic devices include, without limitation, waveguides, splitters, array waveguides, couplers, spectral filters, polarizers, isolators, wavelength division multiplexing structures, optical switches, diffraction gratings, interconnects, attenuators, amplifiers, and the like. The present compositions and films therefrom are also suitable for use in antireflectant coatings, scratch resistant coatings, and the like. Any suitable means may be used to dispose the organic polysilica partial condensates on a substrate, such as dip coating, spin coating, roll coating, curtain coating, spray coating, vapor deposition techniques, such as chemical vapor deposition, and the like.

Typically, the partial condensates are disposed on the substrate as a composition including one or more solvents. Suitable solvents are any which dissolve or disperse the partial condensates and include, but are not limited to, ketones such as methyl isobutyl ketone, diisobutyl ketone, cyclohexanone, and 2-heptanone, lactones such as γ-butyrolactone and ε-caprolactone, esters such as ethyl lactate, n-amyl acetate, n-butyl acetate, and propyleneglycol monomethyl ether acetate, ethers such as propyleneglycol monomethyl ether, diphenyl ether and anisole, nitrogen-containing solvents such as N-methyl-2-pyrrolidone and N,N′-dimethylpropyleneurea, aromatic hydrocarbons such as mesitylene and xylenes, or mixtures thereof.

After being deposited on a substrate, the organic polysilica partial condensate is then substantially cured to form a rigid, cross-linked organic polysilica material. The curing of the organic polysilica material may be by any means known in the art including, but not limited to, heating, exposure to antinic radiation such as UV and e-beam irradiation and combinations thereof. Typically, the partial condensate is cured by heating at an elevated temperature, e.g. either directly such as heating at a constant temperature such as on a hot plate, or in a step-wise manner. Typically, the organic polysilica material is heated at a temperature of from 100° to 450° C.

In an alternate embodiment, the present partial condensates may be used to form porous organic polysilica films. In this embodiment, a composition including an organic polysilica partial condensate, a porogen and optionally a solvent is disposed on a substrate. The term “porogen” refers to a pore forming material that is dissolved or dispersed in an layer of the organic polysilica material and that is removed to form pores or voids in the organic polysilica material. The porogens may be solvents, polymers such as linear polymers, uncross-linked polymers or polymeric particles, monomers or polymers that are co-polymerized with the organic polysilica material to form a block copolymer having a labile (removable) component. In an alternative embodiment, the porogen may be pre-polymerized with the organic polysilica material prior to being disposed on the substrate. Any of the above described solvents may be employed these compositions. Any of the above described disposing means may also be used to dispose any of these porogen containing compositions on a substrate.

Preferably, the porogen is substantially non-aggregated or non-agglomerated in the partial condensate material. Such non-aggregation or non-agglomeration reduces or avoids the problem of killer pore or channel formation in the organic polysilica material. It is preferred that the removable porogen is a porogen particle or is co-polymerized with the organic polysilica partial condensate, and more preferably a porogen particle. It is further preferred that the porogen particle is substantially compatible with the organic polysilica partial condensate. By “substantially compatible” is meant that a composition of organic polysilica partial condensate and porogen is slightly cloudy or slightly opaque. Preferably, “substantially compatible” means at least one of a solution of organic polysilica partial condensate and porogen, a film or layer including a composition of organic polysilica partial condensate and porogen, a composition including an organic polysilica partial condensate having porogen dispersed therein, and the resulting porous organic polysilica material after removal of the porogen is slightly cloudy or slightly opaque. To be compatible, the porogen must be soluble or miscible in the organic polysilica partial condensate, in the solvent used to dissolve the partial condensate or both. Suitable compatibilized porogens are those disclosed in U.S. Pat. No. 6,271,273 (You et al.) and U.S. Pat. No. 6,420,441 (Allen et al.). Other suitable removable particles are those disclosed in U.S. Pat. No. 5,700,844.

Substantially compatibilized porogens are preferably polymer particles. These particles typically have a molecular weight in the range of 10,000 to 1,000,000, preferably 20,000 to 500,000, and more preferably 20,000 to 100,000. The particle size polydispersity of these materials is in the range of 1 to 20, preferably 1.001 to 15, and more preferably 1.001 to 10. It is preferred that such substantially compatibilized porogens are cross-linked. Typically, the amount of cross-linking agent is at least 1% by weight, based on the weight of the porogen. Up to and including 100% cross-linking agent, based on the weight of the porogen, may be effectively used in the particles of the present invention. It is preferred that the amount of cross-linker is from 1% to 80%, and more preferably from 1% to 60%.

Particularly useful compatibilized porogens are those containing as polymerized units at least one compound selected from silyl containing monomers or poly(alkylene oxide) monomers and one or more cross-linking agents. Such porogens are described in U.S. Pat. No. 6,271,273. Suitable silyl containing monomers include, but are not limited to, vinyltrimethylsilane, vinyltriethylsilane, vinyltrimethoxysilane, vinyltriethoxysilane, γ-trimethoxysilylpropyl (meth)acrylate, divinylsilane, trivinylsilane, dimethyldivinylsilane, divinylmethylsilane, methyltrivinylsilane, diphenyldivinylsilane, divinylphenylsilane, trivinylphenylsilane, divinylmethylphenylsilane, tetravinylsilane, dimethylvinyldisiloxane, poly(methylvinylsiloxane), poly(vinylhydrosiloxane), poly(phenylvinylsiloxane), allyloxy-tert-butyldimethylsilane, allyloxytrimethylsilane, allyltriethoxysilane, allyltri-iso-propylsilane, allyltrimethoxysilane, allyltrimethylsilane, allyltriphenylsilane, diethoxy methylvinylsilane, diethyl methylvinylsilane, dimethyl ethoxyvinylsilane, dimethyl phenylvinylsilane, ethoxy diphenylvinylsilane, methyl bis(trimethylsilyloxy)vinylsilane, triacetoxyvinylsilane, triethoxyvinylsilane, triethylvinylsilane, triphenylvinylsilane, tris(trimethylsilyloxy)vinylsilane, vinyloxytrimethylsilane and mixtures thereof. The amount of siliyl containing monomer useful to form the porogens of the present invention is typically from 1 to 99% wt, based on the total weight of the monomers used. It is preferred that the silyl containing monomers are present in an amount of from 1 to 80% wt, and more preferably from 5 to 75% wt.

Suitable poly(alkylene oxide) monomers include, but are not limited to, poly(propylene oxide) monomers, poly(ethylene oxide) monomers, poly(ethylene oxide/propylene oxide) monomers, poly(propylene glycol) (meth)acrylates, poly(propylene glycol) alkyl ether (meth)acrylates, poly(propylene glycol) phenyl ether (meth)acrylates, poly(propylene glycol) 4-nonylphenol ether (meth)acrylates, poly(ethylene glycol) (meth)acrylates, poly(ethylene glycol) alkyl ether (meth)acrylates, poly(ethylene glycol) phenyl ether (meth)acrylates, poly(propylene/ethylene glycol) alkyl ether (meth)acrylates and mixtures thereof. Preferred poly(alkylene oxide) monomers include trimethoylolpropane ethoxylate tri(meth)acrylate, trimethoylolpropane propoxylate tri(meth)acrylate, poly(propylene glycol) methyl ether acrylate, and the like. Particularly suitable poly(propylene glycol) methyl ether acrylate monomers are those having a molecular weight in the range of from 200 to 2000. The poly(ethylene oxide/propylene oxide) monomers useful in the present invention may be linear, block or graft copolymers. Such monomers typically have a degree of polymerization of from 1 to 50, and preferably from 2 to 50. Typically, the amount of poly(alkylene oxide) monomers useful in the porogens of the present invention is from 1 to 99% wt, based on the total weight of the monomers used. The amount of poly(alkylene oxide) monomers is preferably from 2 to 90% wt, and more preferably from 5 to 80% wt.

The silyl containing monomers and the poly(alkylene oxide) monomers may be used either alone or in combination to form the porogens of the present invention. In general, the amount of the silyl containing monomers or the poly(alkylene oxide) monomers needed to compatiblize the porogen with the dielectric matrix depends upon the level of porogen loading desired in the matrix, the particular composition of the organo polysilica dielectric matrix, and the composition of the porogen polymer. When a combination of silyl containing monomers and the poly(alkylene oxide) monomers is used, the amount of one monomer may be decreased as the amount of the other monomer is increased. Thus, as the amount of the silyl containing monomer is increased in the combination, the amount of the poly(alkylene oxide) monomer in the combination may be decreased.

Suitable block copolymers having labile components useful as removable porogens are those disclosed in U.S. Pat. Nos. 5,776,990 and 6,093,636. Such block copolymers may be prepared, for example, by using as pore forming material highly branched aliphatic esters that have functional groups that are further functionalized with appropriate reactive groups such that the functionalized aliphatic esters are incorporated into, i.e. copolymerized with, the vitrifying polymer matrix. Such block copolymers are suitable for forming porous organic polysilica materials, such as benzocyclobutenes, poly(aryl esters), poly(ether ketones), polycarbonates, polynorbornenes, poly(arylene ethers), polyaromatic hydrocarbons, such as polynaphthalene, polyquinoxalines, poly(perfluorinated hydrocarbons) such as poly(tetrafluoroethylene), polyimides, polybenzoxazoles and polycycloolefins.

To be useful in forming porous organic polysilica materials, the porogens of the present invention must be at least partially removable under conditions which do not adversely affect the organic polysilica material, preferably substantially removable, and more preferably completely removable. By “removable” is meant that the porogen degrades, depolymerizes or otherwise breaks down into volatile components or fragments which are then removed from, or migrate out of, the organic polysilica material yielding pores or voids. Any procedures or conditions which at least partially remove the porogen without adversely affecting the organic polysilica material may be used. It is preferred that the porogen is substantially removed. Typical methods of removal include, but are not limited to: exposure to heat, pressure, vacuum or radiation such as, but not limited to, actinic, IR, microwave, UV, x-ray, gamma ray, alpha particles, neutron beam, electron beam, dissolution, chemical etching and the like. It will be appreciated that more than one method of removing the porogen or polymer may be used, such as a combination of heat and actinic radiation. It is preferred that the organic polysilica material is exposed to heat or UV light to remove the porogen. It will also be appreciated by those skilled in the art that other methods of porogen removal, such as by atom abstraction, may be employed.

The porogens can be thermally removed under vacuum, nitrogen, argon, mixtures of nitrogen and hydrogen, such as forming gas, or other inert or reducing atmosphere. The porogens may be removed at any temperature that is higher than the thermal curing temperature and lower than the thermal decomposition temperature of the dielectric matrix material. Typically, the porogens may be removed at temperatures in the range of 150° to 450° C. and preferably in the range of 250° to 425° C. Typically, the porogens are removed upon heating for a period of time in the range of 1 to 120 minutes. After removal from the dielectric matrix material, 0 to 20% by weight of the porogen typically remains in the porous organic polysilica material.

In one embodiment, when a porogen of the present invention is removed by exposure to radiation, the porogen polymer is typically exposed under an inert atmosphere, such as nitrogen, to a radiation source, such as, but not limited to, visible or ultraviolet light. While not intending to be bound by theory, it is believed that porogen fragments form, such as by radical decomposition, and are removed from the matrix material under a flow of inert gas. The energy flux of the radiation must be sufficiently high such that porogen particles are at least partially removed.

The removable porogens are typically added to the organic polysilica partial condensates of the present invention in an amount sufficient to provide the desired lowering of the dielectric constant of the resulting film. For example, the porogens may be added to the partial condensate in any amount of from 1 to 90 wt %, based on the weight of the partial condensate, preferably from 10 to 80 wt %, more preferably from 15 to 60 wt %, and even more preferably from 20 to 30 wt %.

When the porogens are not components of a block copolymer, they may be combined with the organic polysilica partial condensate by any methods known in the art. Typically, the partial condensate is first dissolved or dispersed in a suitable solvent, such as those described above. The porogens are then dispersed or dissolved within the solution. The resulting composition (e.g. dispersion, suspension or solution) is then deposited on a substrate by any of the methods described above to form a film or layer.

After being deposited on a substrate, the partial condensate material is then at least partially cured, and preferably substantially cured, to form a rigid, cross-linked organic polysilica material, as described above, without substantially removing the porogen. After such at least partial curing, the porogen is removed by any of the means described above to form a porous organic polysilica material.

The organic polysilica films and porous organic polysilica films prepared using the present partial condensates have better mechanical properties than corresponding films prepared using partial condensates having higher weight average molecular weights. In particular, such films have higher elastic modulus values when compared to the same films prepared using organic polysilica partial condensates having weight average molecular weights of >10,000.

The present invention further provides a method of manufacturing a device including the steps of: a) disposing on a substrate an organic polysilica partial condensate as described above; and b) curing the organic polysilica partial condensate to form an organic polysilica film. Such method may be used in the manufacture of electronic or optoelectronic devices, as well as in the manufacture of other devices.

The following examples are presented to illustrate further various aspects of the present invention, but are not intended to limit the scope of the invention in any aspect.

### EXAMPLE 1

All glassware is acid washed. Methyl triethoxysilane (MESQ), and 1,2-bistriethoxysilylethane (BESE) are obtained from Aldrich (Milwaukee, Wis.) and used without further purification.

Malonic acid is also obtained from Aldrich and is purified by treatment with a conditioned IRN-77 strong acid nuclear grade ion exchange resin (Rohm and Haas Company, Philadelphia, Pa.). A solution of malonic acid at 5.0% solids is prepared in PGMEA, and the solution is charged 10:1 on a weight basis (polymer solution to resin) with the conditioned ion exchange resin. After 1.5 hr., the solution is filtered through a 0.2 or 0.1 μm filter to remove the ion exchange resin.

A 500 mL 3-neck round bottom flask equipped with a thermometer, condenser, nitrogen inlet, and a magnetic stirrer is charged with 80.00 g (0.4487 mol) of MESQ, 81.97 g (0.2311 mol) of BESE, 32.01 g (0.65 eq) water, 100 g of electronics grade PGMEA and 3 ppm of hydrochloric acid. The reaction mixture is then stirred at 25° C. for 18 hours. The ratio of MESQ/BESE in the polymer is 66/34.

Ethanol and water are then were removed under reduced pressure (aspirator vacuum at 35° C.) on a rotary evaporator for 45 min. The reaction is quenched (acid catalyst removal) by the ion exchange method described below. The reaction mixture is then dried in vacuuo (1 mm Hg at 25° C.) for an additional 3 hours to remove any additional water and ethanol. The polymer solution is next treated with an ion exchange resin in a batch mode to remove metals and is then stabilized with 1000 ppm of malonic acid. The resulting polymer has a Mw of 2,625, a Mn of 1,260 and contained 0.07% water.

Ion exchange treatment of organic polysilica polymer solutions for catalyst removal: A solution of the organic polysilica partial condensate (silsesquioxane), 20-40% solids in PGMEA is charged 10:1 on a weight basis (polymer solution to ion exchange resin) with a conditioned IRA-67 ion exchange resin in a NALGENE high density polyethylene (“HDPE”) bottle. The slurry is agitated using a roller for 1.5 hr. The ion exchange resin is then removed by filtration. With this treatment, the hydrochloric acid catalyst is removed and the shelf life of the partial condensate is greatly extended.

Batch process for ion exchange of organic polysilica polymer solutions for metals removal: A solution of the organic polysilica partial condensate (silsesquioxane), 20-40% solids in PGMEA is charged 10:1 on a weight basis (polymer solution to ion exchange resin) with a conditioned mixed bed ion exchange resin in a NALGENE high density polyethylene (“HDPE”) bottle. The slurry is agitated using a roller for 1.5 hr. At the end of this time, the slurry is filtered through a 0.2 or 0.1 μm filter to remove the ion exchange resin or gels that may result from the ion exchange process. The solution is charged with ca. 1000 ppm of malonic acid (charged as a 5% solution), then is assayed for solids content by heating samples in triplicates of known weight to 150° C. under N₂ flow for 2 hr., measuring the final weight, and calculating the solids content as a percentage of the initial weight.

### EXAMPLE 2

The procedure of Example 1 is repeated except that the reaction time or the catalyst level is changed to provide a number of organic polysilica polymers having a MESQ/BESE ratio of 66/34 but having weight average molecular weights varying from 2500 to 22,000. Shorter reaction times and lower reaction temperatures yield partial condensates having lower weight average molecular weights.

### EXAMPLE 3

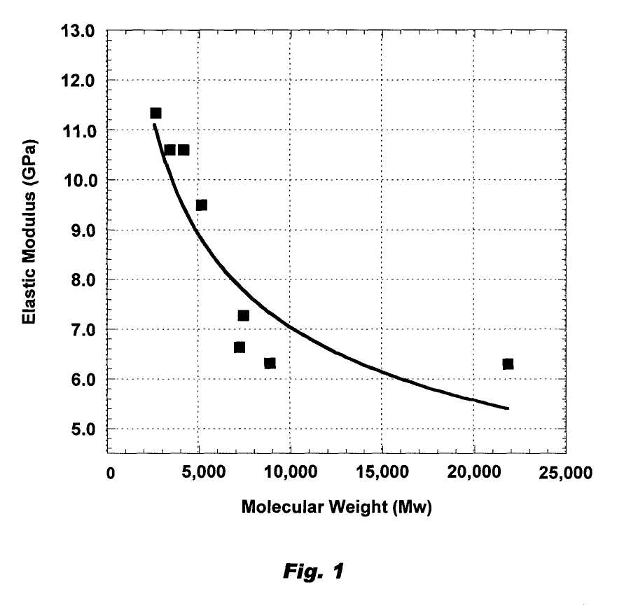

Films of the organic polysilica polymers of Examples 1 and 2 are prepared by spin coating a composition of the organic polysilica partial condensates in PGMEA onto a wafer. The partial condensates are first baked at 150° C. for 1 minute to remove any solvent, followed by heating at a rate of 10° C. per min from room temperature to 450° C. to cure the film. The organic polysilica films are then evaluated to determine the elastic modulus. FIG. 1 shows a plot of the elastic modulus (in GPa) versus the weight average molecular weights of the partial condensates used to prepare the films. Modulus values were determined using an MTS or Hysitron nanoindentation instrument and standard techniques. As can be seen from this plot, the elastic modulus is higher when organic polysilica partial condensates having lower molecular weights are used to prepare the films.

### EXAMPLE 4

The procedure of Example 3 is repeated except that a porogen composition containing a cross-linked polymer particle of methoxypolypropyleneglycol(260)acrylate/trimethylolpropane trimethacrylate (90/10) in PGMEA was added at either 20 or 30% wt based on the weight of the organic polysilica partial condensate and the film was heated at a rate of 10° C. per min from room temperature to 450° C. to cure the film and remove the porogen.

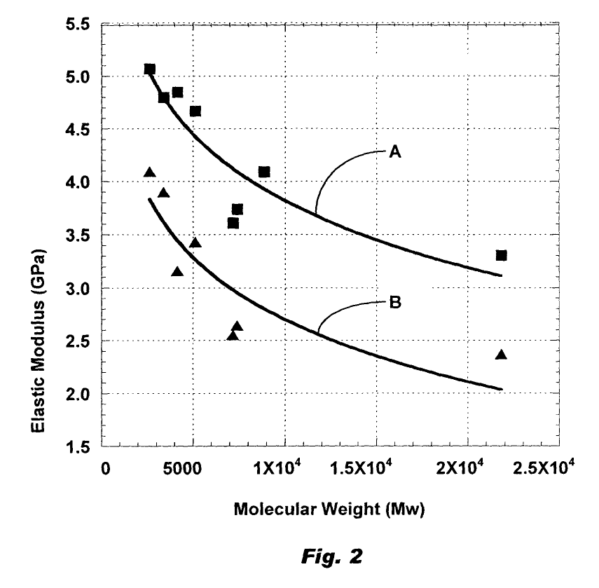

The porous organic polysilica films are then evaluated to determine the elastic modulus. FIG. 2 shows a plot of the elastic modulus (in GPa) versus the weight average molecular weights of the partial condensates used to prepare both the 20% (line A) and 30% (line B) porous films. As can be seen from these plots, the elastic modulus is higher when organic polysilica partial condensates having lower molecular weights are used to prepare the porous films.

### EXAMPLE 5 (COMPARATIVE)

The procedure of Example 1 is repeated except that the partial condensation reaction is performed at 78° C. for 1 hr instead of 25° C. for 18 hrs. The organic polysilica partial condensate produced has a molecular weight of Mw=36,857.

### EXAMPLE 6 (COMPARATIVE)

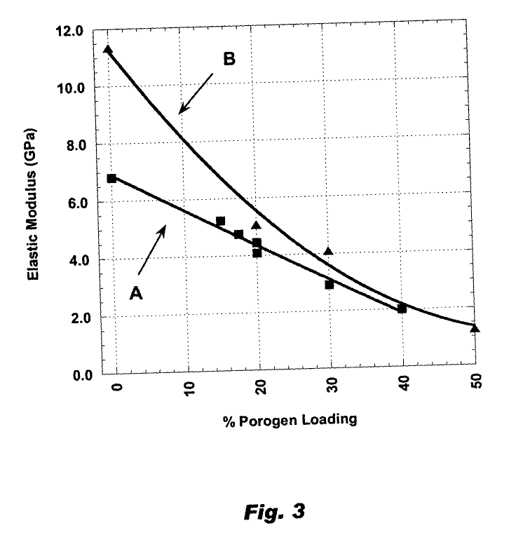

The procedure of Example 4 is repeated except that the porogens are added to the organic polysilica partial condensate of Example 5. The porogens are added at a levels of 0 to 50% wt. Porous organic polysilica films are then prepared and their modulus determined according to the procedure of Example 3. These data are shown in FIG. 3, line A.

### EXAMPLE 7

The procedure of Example 4 is repeated except that the porogens are added to the organic polysilica partial condensate of prepared according to Example 1 and having a weight average molecular weight of approximately 5000. The porogens are added at a levels of 0 to 50% wt. Porous organic polysilica films are then prepared and their modulus determined according to the procedure of Example 3. These data are shown in FIG. 3, line B.

From the data in the plots shown in FIG. 5, it is clear that films prepared from partial condensates prepared by the low temperature process of Example 1 have a higher elastic modulus than films produced from partial condensates prepared at higher temperatures.

### EXAMPLES 7-15

The procedure of Example 1 is repeated except that the ratio of MESQ to BESE is varied. The ratios of MESQ and BESE are reported in Table 1. In each case, the weight average molecular weight is ≦10,000, as determined by GPC using a polystyrene standard.

TABLE 1

| Example | MESQ | BESE |
|---|---|---|
| 7 | 60 | 40 |
| 8 | 50 | 50 |
| 9 | 40 | 60 |
| 10 | 45 | 55 |
| 11 | 70 | 30 |
| 12 | 75 | 25 |
| 13 | 35 | 65 |
| 14 | 84 | 16 |
| 15 | 78 | 22 |

### EXAMPLES 16-30

The procedure of Example 1 is repeated except that the MESQ and BESE are replaced with the compounds and in the amounts shown in Table 2.

TABLE 2

| | Compound of | Compound of | |
|---|---|---|---|
| Example | Formula I | Formula II | Ratio of I/II |
| 16 | ETES | BESE | 58/42 |
| 17 | MTMS | BESM | 80/20 |
| 18 | PhTES | BESE | 40/60 |
| 19 | MTES/PhTES | BESE | 40/25/35 |
| 20 | MTES | BTSE | 55/45 |
| 21 | ETES | BTEP | 55/45 |
| 22 | MTES | BTSB | 50/50 |
| 23 | MTES | BTSH | 25/75 |
| 24 | MTES | BTSH | 55/45 |
| 25 | MTES/PhTES | BESE | 25/55/20 |
| 26 | MTES/PhTES | BESE | 50/25/25 |
| 27 | MTES/PhTES | BESE | 34/33/33 |
| 28 | MTES/TEOS | BESE | 50/25/25 |
| 29 | MTES/TEOS | BESDVB | 50/25/25 |
| 30 | MTES | BESCOD | 66/34 |

TABLE 3

| Abbreviation | Compound |
|---|---|
| ETES | Ethyl triethoxysilane |
| MTMS | Methyl trimethoxysilane |
| PhTES | Phenyl triethoxysilane |
| BTEP | 1,3-Bis(triethoxysilyl)propane |
| BTSB | 1,4-Bis(triethoxysilyl)benzene |
| BTSH | 1,6-Bis(triethoxysilyl)hexane |
| BESDVB | 1,4-Bis(triethoxysilylethyl)benzene |
| BESCOD | 1,3-Bistriethoxysilylcyclooctadiene |
| TEOS | Tetraethylorthosilicate |
| MTES | Methyl triethoxysilane |
| BESM | bistriethoxysilylmethane |

The weight average molecular weight, as determined by GPC using a polystyrene standard, for each of the partial condensates of Examples 16-30 is ≦10,000.

What is claimed is:

1. A composition comprising an organic polysilica partial condensate of one or more silanes of formula (I) and one or more silanes of formula (II):
RₐSiY₄₋ₐ (I)
R¹_{b}(R²O)_{3-b}Si(R³)_{c}Si(OR⁴)_{3-d}R⁵_{d} (II)
wherein R is hydrogen, (C₁-C₈)alkyl, (C₇-C₁₂)arylalkyl, substituted (C₇-C₁₂)arylalkyl, aryl, and substituted aryl; Y is any hydrolyzable group; a is an integer of 1 to 2; R¹, R², R⁴ and R⁵ are independently selected from hydrogen, (C₁-C₆)alkyl, (C₇-C₁₂)arylalkyl, substituted (C₇-C₁₂)arylalkyl, aryl, and substituted aryl; R³ is (C₁-C₁₀)alkyl, —(CH₂)ₕ—, —(CH₂)ₕ₁-Eₖ-(CH₂)ₕ₂—, —(CH₂)ₕ-Z, arylene, substituted arylene, or arylene ether; E is oxygen, NR⁶ or Z; Z is aryl or substituted aryl; R⁶ is hydrogen, (C₁-C₆)alkyl, aryl or substituted aryl; b and d are each an integer of 0 to 2; c is an integer of 0 to 6; and h, h1, h2 and k are independently an integer from 1 to 6; provided that at least one of R, R¹, R³ and R⁵ is not hydrogen; wherein the partial condensate has a weight average molecular weight of ≦10,000.

2. The composition of claim 1 wherein R³ is selected from the group consisting of methylene, ethylene, propylene, butylene, hexylene, norbornylene, cycloheylene, phenylene, phenylene ether, naphthylene and —CH₂—C₆H₄—CH₂—.

3. The composition of claim 1 wherein the organic polysilica partial condensate further comprises one or more silanes of the formula
Mⁿ(OR¹¹)ₙ
wherein M is aluminum, titanium, zirconium, silicon, magnesium, or boron; R¹¹ is (C₁-C₆)alkyl, acyl, or Si(OR¹²)₃; R¹² is (C₁-C₆)alkyl or acyl; and n is the valence of M.

4. The composition of claim 1 wherein the partial condensate has a weight average molecular weight in the range of 2500 to 10,000.

5. A method of preparing an organic polysilica film comprising the step of providing a partial condensate of one or more silanes of formula (I) and one or more silanes of formula (II):
RₐSiY₄₋ₐ (I)
R¹_{b}(R²O)_{3-b}Si(R³)_{c}Si(OR⁴)_{3-d}R⁵_{d} (II)
wherein R is hydrogen, (C₁-C₈)alkyl, (C₇-C₁₂)arylalkyl, substituted (C₇-C₁₂)arylalkyl, aryl, and substituted aryl; Y is any hydrolyzable group; a is an integer of 1 to 2; R¹, R², R⁴ and R⁵ are independently selected from hydrogen, (C₁-C₆)alkyl, (C₇-C₁₂)arylalkyl, substituted (C₇-C₁₂)arylalkyl, aryl, and substituted aryl; R³ is (C₁-C₁₀)alkyl, —(CH₂)ₕ—, —(CH₂)ₕ₁-Eₖ-(CH₂)ₕ₂—, —(CH₂)ₕ-Z, arylene, substituted arylene, or arylene ether; E is oxygen, NR⁶ or Z; Z is aryl or substituted aryl; R⁶ is hydrogen, (C₁-C₆)alkyl, aryl or substituted aryl; b and d are each an integer of 0 to 2; c is an integer of 0 to 6; and h, h1, h2 and k are independently an integer from 1 to 6; provided that at least one of R, R¹, R³ and R⁵ is not hydrogen; wherein the partial condensate has a weight average molecular weight of ≦10,000.

6. The method of claim 5 wherein the partial condensate has a weight average molecular weight in the range of 2500 to 10,000.

7. The method of claim 5 wherein partial condensate further comprises one or more silanes of the formula
Mⁿ(OR¹¹)ₙ
wherein M is aluminum, titanium, zirconium, silicon, magnesium, or boron; R¹¹ is (C₁-C₆)alkyl, acyl, or Si(OR¹²)₃; R¹² is (C₁-C₆)alkyl or acyl; and n is the valence of M.

8. The method of claim 5 wherein R³ is selected from the group consisting of methylene, ethylene, propylene, butylene, hexylene, norbornylene, cycloheylene, phenylene, phenylene ether, naphthylene and —CH₂—C₆H₄—CH₂—.

9. A method of manufacturing a device comprising the steps of:
a) disposing on a substrate an organic polysilica partial condensate of one or more silanes of formula (I) and one or more silanes of formula (II):
RₐSiY₄₋ₐ (I)
R¹_{b}(R²O)_{3-b}Si(R³)ₙSi(OR⁴)_{3-d}R⁵_{d} (II)
wherein R is hydrogen, (C₁-C₈)alkyl, (C₇-C₁₂)arylalkyl, substituted (C₇-C₁₂)arylalkyl, aryl, and substituted aryl; Y is any hydrolyzable group; a is an integer of 1 to 2; R¹, R², R⁴ and R⁵ are independently selected from hydrogen, (C₁-C₆)alkyl, (C₇-C₁₂)arylalkyl, substituted (C₇-C₁₂)arylalkyl, aryl, and substituted aryl; R³ is (C₁-C₁₀)alkyl, —(CH₂)ₕ—, —(CH₂)ₕ₁-Eₖ-(CH₂)ₕ₂—, —(CH₂)ₕ-Z, arylene, substituted arylene, or arylene ether; E is oxygen, NR⁶ or Z; Z is aryl or substituted aryl; R⁶ is hydrogen, (C₁-C₆)alkyl, aryl or substituted aryl; b and d are each an integer of 0 to 2; c is an integer of 0 to 6; and h, h1, h2 and k are independently an integer from 1 to 6; provided that at least one of R, R¹, R³ and R⁵ is not hydrogen; wherein the partial condensate has a weight average molecular weight of ≦10,000; and
b) curing the organic polysilica partial condensate to form an organic polysilica film.

10. The method of claim 9 wherein the organic polysilica partial condensate further comprises one or more silanes of the formula
Mⁿ(OR¹¹)ₙ
wherein M is aluminum, titanium, zirconium, silicon, magnesium, or boron; R¹¹ is (C₁-C₆)alkyl, acyl, or Si(OR¹²)₃; R¹² is (C₁-C₆)alkyl or acyl; and n is the valence of M.

11. The method of claim 9 wherein the partial condensate has a weight average molecular weight in the range of 2500 to 10,000.

12. The method of claim 9 wherein R³ is selected from the group consisting of methylene, ethylene, propylene, butylene, hexylene, norbornylene, cycloheylene, phenylene, phenylene ether, naphthylene and —CH₂—C₆H₄—CH₂—.

13. The method of claim 9 wherein the device is selected from the group consisting of electronic devices, optoelectronic devices, optical devices, and display devices.

14. A method of preparing an organic polysilica partial condensate comprising the steps of: a) reacting one or more organosilanes and water in the presence of a condensation catalyst at a temperature and time sufficient to provide an organic polysilica partial condensate having a desired molecular weight, and b) treating the partial condensate with a catalyst removing agent, to remove substantially all of the catalyst.

15. The method of claim 14 wherein less than 1% of the catalyst remains after treatment with the catalyst removing agent.
